(19) United States
(12) Patent Application Publication
(10) Pub. No.: US 2013/0248671 A1
(43) Pub. Date: Sep. 26, 2013

(54) USE OF FIBRE-REINFORCED POLYURETHANE TO FORM A RAIL FOR A MOUNTING ARRANGEMENT

(71) Applicant: BAYER INTELLECTUAL PROPERTY GMBH, Monheim (DE)

(72) Inventors: Stephan Schleiermacher, Pulheim (DE); Haval Khaffaf, Koln (DE); Thomas Kleiner, Odenthal (DE); Hans-Guido Wirtz, Leverkusen (DE)

(73) Assignee: Bayer Intellectual Property GmbH, Monheim (DE)

(21) Appl. No.: 13/847,538

(22) Filed: Mar. 20, 2013

(30) Foreign Application Priority Data
Mar. 22, 2012 (EP) 12160840.0

(51) Int. Cl. F16M 13/02

(52) U.S. Cl. CPC F16M 13/02
USPC 248/309.1; 29/428

(57) ABSTRACT

The invention relates to the use of fibre-reinforced polyurethane to form a rail (10, 11) for a mounting arrangement to arrange at least one element (12) on a substrate (13) or on at least one receiving structure, in particular on a framework, where the rail (10, 11) has a C-shaped cross section with an open side (14), so that it is possible for the rail (10, 11) to receive at least one rear-engaging element (15) to connect to the element (12) to be arranged.

The present invention relates to a rail for a mounting arrangement to arrange at least one element on a substrate or on a receiving structure, in particular on a framework, where the rail has a C-shaped cross section with an open side, in such a way that at least one rear-engaging element can be received in the rail for connection to the element to be arranged.

The substrate can by way of example be the external wall or the slab edge of a building, or a receiving structure, in particular a framework, can form the substrate. By way of example, industrial buildings, in particular cold stores, can be composed of a steel framework on which elements can be applied externally or internally, in particular thermally insulating facade elements. Rails are used to apply the elements on the substrate or on the receiving structure, and if the rails are arranged on a substrate made of a hardenable material, the rails then comprise anchors which can be let into the hardenable material. If the rails are arranged on a receiving structure, for example on a steel framework, the rails are then mostly attached on the framework by the reverse side opposite to the open side.

The rear-engaging element for arrangement in the rail can by way of example be a hammerhead bolt, but there are also known slot nuts into which it is possible to screw a screw-thread shaft which extends through a continuous slot in the open side of the rail and to which the element can be secured. The advantage of using a rail is that the arrangement of the element is flexible in the longitudinal direction of the rail, since the rear-engaging element can be anchored at any desired position in the rail, along the length of the rail.

The element which can be arranged by means of the rail on the substrate or on the receiving structure, in particular on the framework, can by way of example be a facade element, but it is also possible here to arrange other elements, such as panels, cladding elements, protective elements, or indeed masonry, on the substrate or on the receiving structure, by virtue of the rail, by way of allocated rear-engaging elements. It is equally possible to undertake installations of cables, pipes or retainers, for example for the catenary of a railway system, in the form of elements with this type of rail on a wall, for example on the internal wall in a tunnel, or on a receiving structure.

DE 10 2009 033 804 A1 discloses a rail for a mounting arrangement to arrange an element on a receiving structure, and in the arrangement shown a solar panel forms the element. The rail has an open side into which a rear-engaging element has been inserted and is used for the connection to the solar panel. The rail is termed mounting rail and it is stated that this is produced by a pultrusion process, an extrusion process or a similar process from an aluminium alloy. It is further stated that rails of this type can be produced from sheet metal and that they usually have a C-shaped cross section with a continuous slot.

DE 10 2009 030 768 A1 discloses a rail for a mounting arrangement to arrange an element on a wall or on a receiving structure, and the rail can be produced by an appropriate forming process from sheet metal or by a pultrusion process or an extrusion process. Rear-engaging elements can be inserted into the rail for connection to the element to be attached, and the rear-engaging elements can be arranged to be movable in the longitudinal direction of the rail.

DE 10 2010 028 349 A1 discloses a rail for a mounting arrangement on a wall, where the rail is an anchor rail and the rail has been let into a concrete structure that forms the wall. The rail has an open side with a continuous slot, into which it is possible to insert rear-engaging elements which can be connected to the element to be attached. With reference to the material of the rail, it is stated that this can be composed of iron, of steel, of aluminium or of a plastic. These anchor rails or mounting rails are cast into, or embedded into, concrete in construction technology, in such a way that only the open side or another external region of the rail is freely accessible and adjoins the surface of the wall. The rail is an anchor rail with an anchor generally arranged on the reverse side of the rail and thus likewise let into the concrete. Rear-engaging elements can be introduced into the rail, and elements, such as facade elements or else, for example, retainers for cables, hoses or other articles to be mounted on a wall can finally be attached to these.

If the rail comes into contact with concrete, it is desirable that the material of the rail has high chemical resistance to concrete and to other various, in particular basic, media. The rails can moreover serve for arrangement of elements whose function is to reduce heat loss or heat gain, and a requirement can be, depending on the application, that the material of the rail has a low thermal conductivity value, in particular when elements to be attached on a wall form a thermal insulation layer, and heat bridges are to be avoided. A final factor to be taken into account during the selection of material is that the rail must also bear high mechanical loads, depending on the application, and the material of the rail must therefore comply with appropriate strength requirements.

DE 20 2007 003 903 U1 describes anchoring systems for buildings, where a part of the anchoring system can be an anchor rail made of a fibre-reinforced polymer.

In the light of the known prior art, it is an object of the invention to provide a rail which is suitable for a mounting arrangement to arrange at least one element on a substrate or on a receiving structure, and which has very good resistance to alkaline media and moreover exhibits the advantageous properties of conventional mounting rails, for example good mechanical and thermal properties.

The abovementioned object is achieved through the use of fibre-reinforced polyurethane to form a rail for a mounting arrangement to arrange at least one element on a substrate or on a receiving structure, in particular on a framework, where the rail has a C-shaped cross section with an open side, so that it is possible for the rail to receive at least one rear-engaging element to connect to the element to be arranged, where the rail has been produced by a pultrusion process.

A fibre-reinforced polyurethane which is produced in a pultrusion process can be used particularly advantageously to form a rail when the rail is an anchor rail with at least one anchor, and where concrete forms the wall on which the rail is arranged. The rail composed of fibre-reinforced polyurethane here can be cast into the concrete, in particular in such a way that the open side of the rail approximately adjoins the surface of the wall, in such a way that concrete in essence has been cast around the rail. Fibre-reinforced polyurethane which is produced in a pultrusion process features particular resistance to basic media, for example concrete, and an anchor rail which is brought into direct contact with the concrete can therefore be utilized over a long period, because it is chemically resistant.

A hardenable material is in particular concrete, mortar and cement.

The rail can also be a mounting rail, and a mounting rail differs from an anchor rail in that there are no wall anchors arranged on a mounting rail. One possibility is that the mounting rail has likewise been let into a wall, but another possibility is by way of example that it is arranged on a receiving structure, in particular on a framework. A reverse side which, on the mounting rail, is opposite to the open side of the rail with the continuous slot, can serve for connection of the mounting rail to the receiving structure, and the mounting rail can also be secured with the reverse side on the receiving structure, in particular on the framework. The rail has a C shape which can be level, and in which there are two lateral limbs which end at the open side opposite to the reverse side and thus form a C shape of the rail. The two C-shaped ends of the limbs here form the continuous slot on the open side of the rail.

The fibre-reinforced polyurethane for forming a rail, in particular an anchor rail and/or a mounting rail, can comprise a fibre component made of a glass fibre, made of a carbon fibre and/or made of an aramid fibre. Alternative suitable natural fibres are seed fibres, e.g. cotton and kapok, bast fibres, e.g. bamboo, nettle, hemp, jute, kenaf, linen and ramie, leaf fibres, e.g. banana, caroá, curauá, New Zealand flax and sisal, and also fruit fibres, e.g. coconut. Suitable continuous thermoplastic fibres (organic fibres) are fibres made of polyester, in particular polyethylene terephthalate, polyamide, polyacrylonitrile and polymethyl methacrylate. In particular, the rail can be produced by a pultrusion process, and the fibre component can extend in the longitudinal direction of the rail, but in addition at least one component running transversely with respect to the longitudinal direction can reinforce the C-shaped structure of the rail here.

The fibre-reinforced polyurethane can be formed from the components polyol and polyisocyanate, and the components here can by way of example be introduced into an injection box after previous mixing, in order to form a bond with the fibre component, in particular in order to saturate the fibre component.

Polyisocyanates that can be used are any of the aliphatic, cycloaliphatic or aromatic isocyanates known for the production of polyurethanes. Examples are diphenylmethane 2,2-, 2,4- and 4,4′-diisocyanate, the mixtures of monomeric diphenylmethane diisocyanates and of diphenylmethane diisocyanate homologues having a larger number of rings (polymeric MDI), 4,4′-methylenebis(cyclohexyl isocyanate), isophorone diisocyanate (IPDI) or its oligomers, tolylene diisocyanate (TDI), for example isomers of tolylene diisocyanate, such as tolylene 2,4- or 2,6-diisocyanate or a mixture thereof, tetramethylene diisocyanate or its oligomers, hexamethylene diisocyanate (HDI) or its oligomers, naphtylene diisocyanate (NDI) or a mixture thereof Preferred polyisocyanates used are isocyanates based on diphenylmethane diisocyanate, in particular polymeric MDI. The functionality of the polyisocyanate is preferably from 2.0 to 2.9, particularly preferably from 2.1 to 2.8. The viscosity of the polyisocyanates at 25° C. in accordance with DIN 53019-1 to 3 here is preferably from 5 to 600 mPas and particularly preferably from 10 to 300 mPas.

Preferred polyols are polyether polyols and/or polyester polyols having from 2 to 8 hydrogen atoms reactive towards isocyanate. Particularly preferred polyols are polyether polyols. The OH number of these compounds is usually in the range from 12 to 1100 mg KOH/g.

The polyether polyols are obtained by known methods, for example by anionic polymerization of alkylene oxides with addition of at least one starter molecule which comprises from 2 to 8, preferably from 2 to 6 and particularly preferably from 2 to 4, reactive hydrogen atoms, in the presence of catalysts. Catalysts that can be used are alkali metal hydroxides, such as sodium hydroxide or potassium hydroxide, or alkali metal alcoholates, such as sodium methoxide, sodium ethoxide or potassium ethoxide or potassium isopropoxide, or in the case of cationic polymerization Lewis acids, such as antimony pentachloride, boron trifluoride etherate or bleaching earth. Other catalysts that can also be used are double metal cyanide compounds, known as DMC catalysts.

Alkylene oxides used are preferably one or more compounds having from 2 to 4 carbon atoms in the alkylene moiety, such as tetrahydrofuran, ethylene oxide, propylene 1,2-oxide, or butylene 1,2- or 2,3-oxide, in each case alone or in the form of a mixture, and preferably propylene 1,2-oxide, and/or ethylene oxide, in particular propylene 1,2-oxide. Examples of starter molecules that can be used are ethylene glycol, 1,2-propanediol, diethylene glycol, glycerol, trimethylolpropane, pentaerythritol, sugar derivatives, such as sucrose, hexitol derivatives, such as sorbitol, bisphenol A, 2-butene-1,4-diol, toluenediamine, ethylenediamine, diethylenetriamine, 4,4′-methylene-dianiline, 1,3-propanediamine, 1,6-hexanediamine, ethanolamine, diethanolamine, triethanolamine, and also other di or polyhydric alcohols or mono or polybasic amines

The polyester polyols used are mostly produced through condensation of polyhydric alcohols having from 2 to 12 carbon atoms, for example ethylene glycol, diethylene glycol, butanediol, trimethylolpropane, glycerol or pentaerythritol, with polybasic carboxylic acids having from 2 to 12 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid and the isomers of naphthalenedicarboxylic acids or their anhydrides.

The present invention is also directed to a method for the mounting of at least one element on a substrate or on a receiving structure, in particular on a framework, and the method comprises at least the steps of the arrangement, on the substrate or on the receiving structure, of a rail which is made of a fibre-reinforced polyurethane with a C-shaped cross section and which is produced in a pultrusion process, the arrangement of at least one rear-engaging element on the rail and the arrangement of the at least one element onto a rear-engaging element.

A hammerhead bolt can form the rear-engaging element and its head can be inserted into the rail made of fibre-reinforced polyurethane. The substrate can preferably be the external wall of a building, and if facade elements are arranged on the external wall of the building the rail can serve as anchor rail or as mounting rail for the longitudinally variable reception of rear-engaging elements. If the rail is an anchor rail, this comprises at least one anchor, and if a hardenable material forms the substrate the rail can be arranged on the substrate by letting the rail into the hardenable material or casting the hardenable material around the rail.

If the rail is a mounting rail, this preferably serves for arrangement on a receiving structure, in particular on a framework. A substrate made of a hardenable material can likewise form the receiving structure, but the mounting rail has no anchors, and the mounting rail can by way of example be bonded to the substrate by a coherent method, in particular by an adhesive method or by means of at least one means of connection, for example a screw-threaded component or a rivet.

In relation to the implementation of the method, the rail can comprise a fibre-reinforced polyurethane which comprises a fibre component made of a glass fibre, made of glass mats, made of a carbon fibre, made of a polyester fibre, made of a natural fibre, made of an aramid fibre, made of a basalt fibre or made of a nylon fibre, particularly preferably made of a glass fibre, made of a carbon fibre and/or made of an aramid fibre. A pultrusion process is used to produce the rail.

### PREFERRED EXAMPLES OF THE INVENTION

Further measures that improve the invention are depicted in more detail below together with the description of preferred examples of the invention, with reference to the figures, which show the following:

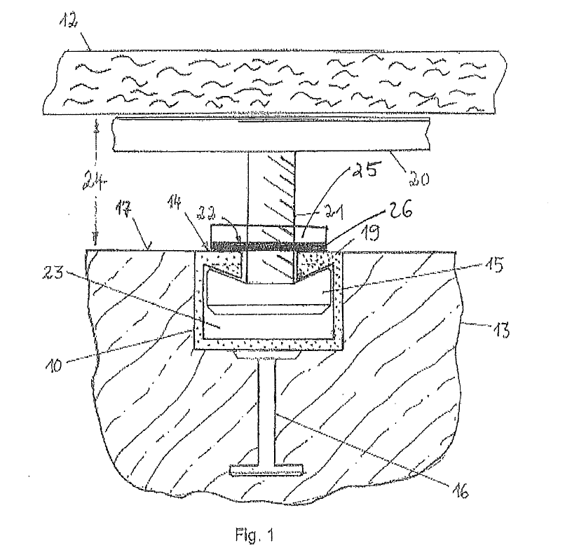

FIG. 1: an example of a mounting arrangement with a rail formed from fibre-reinforced polyurethane,

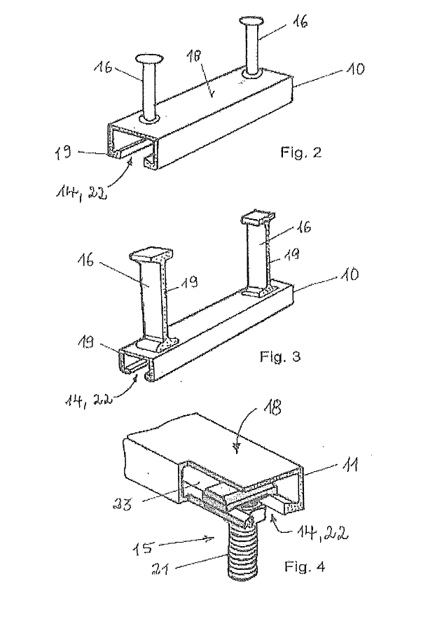

FIG. 2: a perspective view of a rail which is an anchor rail,

FIG. 3 another example of a rail which is an anchor rail and comprises anchors formed, like the rail, from fibre-reinforced polyurethane, and

FIG. 4 an example of a rail which is a mounting rail.

FIG. 1 shows an example of a mounting arrangement with a rail 10, which is an anchor rail 10 and which has an anchor 16 with which the rail has been let into a wall 13. Concrete forms the wall 13, and the rail 10, with the anchor 16, has been let into the concrete.

A fibre-reinforced polyurethane has been used to form the rail 10 and is produced in a pultrusion process, and the cross-sectional view of the rail 10 shows by way of example a fibre component 19, introduced in a polyurethane matrix. The anchor rail 10 has a C-shaped cross section, and the

C-shaped cross section has an open side 14 with a continuous slot 22. The arrangement of the anchor rail 10 in the wall 13 is such that the open side 14 is level with and adjoins the surface 17 of the wall 13. From the cross-sectional view it can be seen that the anchor rail 10 made of fibre-reinforced polyurethane comes into direct contact with the concrete of the wall 13 and in essence has been enclosed by the concrete. Furthermore, the concrete of the wall 13 has been cast around the anchor 16, and the anchor rail 10 is anchored in the wall 13 here with the aid of the anchor 16.

By virtue of its C shape, the anchor rail 10 has a receiving space 23 which extends longitudinally through the rail 10; the receiving space 23 is accessible from the open side 14 of the rail 10 by virtue of the slot which likewise extends along the longitudinal direction of the rail 10.

A rear-engaging element 15 has been arranged on the rail 10 and by way of example is a hammerhead bolt 15. The hammerhead bolt 15 has a head which has been received in the receiving space 23 of the rail 10, and a screw-thread shaft 21 arranged on the head of the hammerhead bolt 15 extends through the slot 22 on the external side of the rail 10. By means of the screw-thread shaft 21 it is possible to arrange the element 12 on the wall 13, and the element 12 can by way of example be a facade element 12. An intermediate element 20 is shown by way of example for arranging the facade element 12 on the screw-thread shaft 21 of the hammerhead bolt 15, and forms, for example, a counter-lath. If the element 12 is, for example, a facade element 12 arranged on the wall 13, a distance 24 between the surface 17 of the wall 13 and the element 12 is advantageous in order to permit air circulation between the wall 13 and the facade element 12.

Another advantage of using fibre-reinforced polyurethane which is produced in a pultrusion process for an anchor rail 10 in the arrangement shown is low thermal conductivity of the fibre-reinforced polyurethane, thus avoiding the formation of heat bridges between the wall 13 and the facade element 12. In particular, hammerhead bolts 15 in the arrangement shown are often produced from a steel material, in order to comply with appropriate strength requirements. If fibre-reinforced polyurethane forms the anchor rail 10, a heat barrier is provided at an early stage, between the wall 13 and the hammerhead bolt 15.

The use of fibre-reinforced polyurethane which is produced in a pultrusion process to form a mounting arrangement with a rail 10 in the arrangement shown can therefore achieve a number of advantages, and advantageous use can be made not only of the advantageous properties of fibre-reinforced polyurethane in particular with respect to resistance to basic media but also of the low thermal conductivity of fibre-reinforced polyurethane. Finally, when fibre-reinforced polyurethane is used to form an anchor rail 10 in the arrangement shown, it also complies with the requirements for high strength, and this strength is substantially higher than the strength of other plastics, in particular when these have no fibre component 19. Examples of various rails 10, 11 in the form of anchor rail 10 or in the form of mounting rail 11 are revealed below. The transverse tensile strength of the anchor rail 10 and mounting rail 11 used according to the invention is respectively>5 kN.

FIG. 2 shows a perspective view of a rail 10 made of a fibre-reinforced polyurethane which is produced in a pultrusion process, with a fibre component 19, as shown by way of example on the cross section of the rail 10. The rail 10 is an anchor rail 10 with anchors 16 which extend approximately perpendicularly on the reverse-side area 18 of the anchor rail 10. The reverse side 18 has been arranged opposite to the open side 14 and forms the base side of the C-shaped cross section of the anchor rail 10. Also shown is the continuous slot 22, which extends along the entire length of the anchor rail 10, through the open side 14.

FIG. 3 shows another example of an anchor rail 10 with a C-shaped cross section; a continuous slot 22 is therefore likewise depicted in the open side 14, and rear-engaging elements 15 can be inserted - as shown in FIG. 1 - through the said slot. The anchor rail 10 comprises anchors 16, likewise formed from a fibre-reinforced polyurethane, and a fibre component 19 has been indicated in the cross section of the anchors 16, as in the cross section of the anchor rail 10 itself

Both the rail 10 and the anchors 16 can have been produced in a pultrusion process. The rail 10 and the anchors 16 can be provided in the form of continuous material by a pultrusion process, and the rails 10 and in particular the anchors 16 can be brought to their appropriate length by an appropriate method of producing specific lengths.

Finally, FIG. 4 shows a perspective view of a rail 11 which is a mounting rail 11. The mounting rail 11 comprises no anchors 16, and the mounting rail 11 is therefore preferably suitable for arrangement on a receiving structure, for example on a framework. The mounting rail 11 here can be arranged coherently or by way of connection elements, such as screw-threaded components or rivets, with the reverse side 18 on the receiving structure. A hammerhead bolt 15 has been received within the receiving space 23 of the mounting rail 11, and a screw-thread shaft 21 of the hammerhead bolt 15 extends out of the continuous slot 22 in the open side 14 of the mounting rail 11. In the same way as the anchor rail 10 according to the preceding examples, the mounting rail 11 can be formed from a fibre-reinforced polyurethane and can have a C-shaped cross section.

Embodiments of the invention are not restricted to the examples revealed above, which are merely preferred. In fact, there is a number of conceivable variants which make use of the solution described, but in embodiments that are of fundamentally different type. All of the features and/or advantages that are apparent from the claims, from the description or from the drawings, inclusive of design details or spatial arrangements, can be significant in the invention, either per se or else in a very wide variety of combinations. In particular, anchor rails 10 or mounting rails 11 can, as is the case with known rails made of metallic materials, have the same wall thickness throughout their C-shaped cross section, or the rails 10, 11 can have thickening on the internal side of the open side 14, namely in the region of contact with the head of the rear-engaging element 15, as shown by way of example in FIG. 4. Production of rails 10, 11 of this type frequently does not involve bending of sheet metal, but instead the prior art produces these rails by way of example by the continuous casting process or by the extrusion process, from an aluminium material. According to the invention, rails of this type can be produced particularly advantageously from a fibre-reinforced polyurethane in the pultrusion process with a wall thickness that is not uniform throughout their C-shaped cross section.

### KEY

10 rail, anchor rail
11 rail, mounting rail
12 element, facade element
13 substrate, wall
14 open side
15 rear-engaging element, hammerhead bolt
16 anchor
17 surface
18 reverse side
19 fibre component
20 intermediate element
21 screw-thread shaft
22 slot
23 receiving space
24 distance
25 locking nut
26 washer

### EXAMPLES

### Example 1

### Production of a Rail Made of Pultruded Polyurethane

The pultrusion plant used comprised a closed injection box and a heatable mould. The width of the flat region of the profile in the mould was 115 mm. The wall thickness of the profile was 3 mm.

Pultrudates were accordingly produced with these dimensions. Standard glass fibres suitable for the pultrusion process were used (Advantex® DR399A-AE 4800 from 3B, Belgium), and were drawn through the injection box and the mould. The total concentration of the reinforcement material, based on the total weight of the pultrudate, was about 80% by weight. The stated starting materials, with the stated isocyanate index, were mixed at room temperature in a low-pressure mixing machine with a static mixer. The reaction mixture was then injected into the injection box, and the glass fibres were thus wetted by the reaction mixture. The wetted glass fibres were continuously drawn through the mould by means of a take-off system, and the polyurethane system was cured in the heated mould. At the end of the process, the profiles were cut to a length of 1 m.

The following materials were processed:

| Polyol A | polyether polyol with hydroxyl number 235 and |
|---|---|
| | viscosity 250 in accordance with DIN EN ISO 3219 |
| Polyol B | trifunctional polyether polyol with hydroxyl number |
| | 450 and viscosity 420 in accordance with DIN EN |
| | ISO 3219 |
| Polyol C | bifunctional polyether polyol with hydroxyl number 28 |
| | and viscosity 980 in accordance with DIN EN |
| | ISO 3219 |
| Polyol D | trifunctional polyether polyol with hydroxyl number |
| | 1050 and viscosity 1350 in accordance with DIN EN |
| | ISO 3219 |
| Molecular sieve | Molsiv ® L Powder, obtainable from |
| | UOP M.S. S.r.I.; Viale Milanofiori, |
| | Strada 1, Palazzo E1, I-20090 ASSAGO MI, Milan |
| Catalyst | FORMREZ ® UL 29 tin catalyst obtainable from GE |
| | Silicones |
| Release agent | Tech-Lube ® HB-550-D (obtainable from |
| | Technick Products Inc., 238 St. |
| | Nicholas Ave., South Plainfield, NJ 07080) |
| Material | Component A (parts by weight) |
| Polyol A | 29.21 |
| Polyol B | 24.33 |
| Polyol C | 19.46 |
| Polyol D | 14.33 |
| Polyol E | 10 |
| Polyol F | 0 |
| Polyol G | 0 |
| Molecular sieve | 2 |
| Catalyst | 0.67 |
| Release agent | 4.0 |

The pultruded polyurethane was produced by reacting 104 parts of component A with 119 parts of MDI (liquid MDI with 40% by weight monomer content, 31.4% by weight of free NCO groups and average functionality 2.8).

### Example 2

### Production of a Rail Made of Epoxy Resin

A rail made of epoxy resin was produced by correspondingly processing 100 parts by weight of MGS 100 RIM-135 infusion resin (obtainable from Hexion®) with 30 parts of MGS RIMH 137 hardener (obtainable from Hexion®) and 3.25 parts of G161 release agent (obtainable from Wela-Handelsgesellschaft).

### Example 3

### Production of a Rail Made of Unsaturated Polyester Resin

A rail made of unsaturated polyester resin was produced by processing 95 parts by weight of Viapal® UP 002/60 (obtainable from Lange+Ritter GmbH), 2 parts by weight of CuroxA® peroxide (obtainable from Lange+Ritter GmbH), 0.5 parts by weight of C101 accelerator (obtainable from Lange+Ritter GmbH) and 2.5 parts by weight of G161 release agent (obtainable from Wela-Handelsgesellschaft).

### Example 4

### Measurement of Interlaminar Shear Strength After Treatment With Alkali

The rails produced according to the preceding examples were subjected to a test for measuring interlaminar shear strength or “ILSS”, the test being well known to the person skilled in the art and described in the ASTM D2344 standard. For this, the rails were stored in 10% aqueous sodium hydroxide solution.

The rail according to Example 1 exhibited no reduction in shear strength after 90 days. The rail according to Example 2 exhibited a reduction of at least 15%, based on the initial value, in shear strength after 59 days. The rail according to Example 3 exhibited a reduction of at least 15%, based on the initial value, in shear strength after 15 days.

The examples show that rails according to the invention, made of pultruded polyurethane, have very good resistance to strongly alkaline media. The said rails are therefore suitable as elements which can be introduced into concrete or secured to concrete.

1. A rail for a mounting arrangement to arrange at least one element on a substrate or on a receiving structure, where the rail has a C-shaped cross section with an open side, so that it is possible for the rail to receive at least one rear-engaging element to connect to the element to be arranged, characterized in that the rail comprises fibre-reinforced polyurethane and has been produced by a pultrusion process.

2. The rail according to claim 1, where the rail is an anchor rail with at least one anchor and where a hardenable material forms the substrate.

3. The rail according to claim 1, where the rail is cast in a hardenable material, in such a way that the open side approximately adjoins a surface of the substrate.

4. The rail according to claim 1, where the rail is a mounting rail for arrangement on a substrate or on a receiving structure, and where the rail is secured on the receiving structure by a reverse side opposite to the open side.

5. The rail according to claim 1, where the fibre-reinforced polyurethane comprises at least one fibre component selected from the group consisting of glass fibres, glass mats, carbon fibres, polyester fibres, natural fibres, aramid fibres, basalt fibres and nylon fibres.

6. The rail according to claim 1, where the polyurethane is formed from at least one polyol selected from the group consisting of polyether polyols and polyester polyols and from at least one polyisocyanate.

7. A method for the mounting of at least one element on a substrate or on a receiving structure, where the method comprises:
arranging a rail made of a fibre-reinforced polyurethane with a C-shaped cross section on the substrate or on the receiving structure,
arranging at least one rear-engaging element on the rail and
arranging the at least one element onto the rear-engaging element, characterized in that the rail has been produced by a pultrusion process.

8. The method according to claim 7, where the at least one element is a facade element and/or where the substrate is an external wall of a building.

9. The method according to claim 7, where the rail is an anchor rail with at least one anchor and where a hardenable material forms the substrate, in such a way that, for the arrangement on the substrate with the anchor, the rail is let into a hardenable material or the hardenable material is cast around the rail.

10. The method according to claim 7, where the rail is a mounting rail for arrangement on a receiving structure, and where, for arrangement on the receiving structure, the rail is bonded coherently to the receiving structure, by an adhesive method, or by means of at least one means of connection.

11. The method according to claim 7, where the fibre-reinforced polyurethane comprises a fibre component made of a glass fibre, made of a carbon fibre and/or made of an aramid fibre, and/or where the rail has been produced by a pultrusion process.

12. The method according to claim 10, wherein the connection is a rivet.
